(19) United States
(12) Patent Application Publication
(10) Pub. No.: US 2024/0254263 A1
(43) Pub. Date: Aug. 1, 2024

(54) Polyethylene Manufacturing Process

(71) Applicants: SK Innovation Co., Ltd., Seoul (KR); SK Geo Centric Co., Ltd., Seoul (KR)

(72) Inventors: Maeng Sun Eo, Daejeon (KR); Mun Hyung Kang, Daejeon (KR); Hye Rin Choi, Daejeon (KR)

(21) Appl. No.: 18/413,181

(22) Filed: Jan. 16, 2024

(30) Foreign Application Priority Data
Jan. 19, 2023 (KR) 10-2023-0008232

(51) Int. Cl. C08F 110/02; C08F 2/06; C08F 4/64

(52) U.S. Cl. CPC C08F 110/02; C08F 2/06; C08F 4/64

(57) ABSTRACT

Provided is a polyethylene manufacturing which is a manufacturing process of supplying a first mixed solution including a monomer, a solvent, and a scavenger and a second mixed solution including a Ziegler-Natta unsupported catalyst and a solvent to a continuous reactor to perform polymerization at a high temperature of 200° C. or more, and may solve a problem of an increase in an added catalyst amount during operation for a long time while having excellent catalytic activity is provided.

### CROSS-REFERENCE TO RELATED APPLICATION

This application claims priority to Korean Patent Application No. 10-2023-0008232, filed Jan. 19, 2023, the disclosure of which is hereby incorporated by reference in its entirety.

### BACKGROUND OF THE INVENTION

### Field of the Invention

The following disclosure relates to a polyethylene manufacturing process.

### DESCRIPTION OF THE INVENTION

In general, polyethylene is manufactured by polymerizing ethylene in the presence of a Ziegler-Natta catalyst or a metallocene catalyst. However, impurities such as alcohols, aldehydes, and ketones may occur during the ethylene polymerization process. Since catalytic activity may be reduced due to the impurities, the yield of polyethylene is decreased. When the solvent is recirculated and used, some impurities remain even after residual impurities are purified, so that the catalytic activity is decreased. In addition, when an unsupported catalyst is used in the ethylene polymerization process, foreign matter occurs in catalyst deactivation and removal processes and the like, which affect the catalytic activity.

### SUMMARY OF THE INVENTION

In some embodiments of the present disclosure, there is provided a polyethylene polymerization method which suppresses a decrease in catalytic activity and/or has high productivity even when ethylene is polymerized using a Ziegler-Natta catalyst.

In some embodiments, the present disclosure is directed to polymerizing polyethylene while suppressing and absorbing impurities such as ketones occurring during polymerization of polyethylene.

In some embodiments, the present disclosure is directed to solve a problem of a gradual increase in a catalyst content in order to maintain polyethylene productivity when impurities occur due to the nature of a continuous process.

In some embodiments, a polyethylene manufacturing process is provided comprising: supplying a first mixture comprising a monomer comprising ethylene, a solvent, and a scavenger to a continuous stirring type reactor through a first line; supplying a second mixture comprising a Ziegler-Natta unsupported catalyst to the continuous stirring type reactor through a second line; and manufacturing a polyethylene polymer in the continuous stirring type reactor, wherein a polymerization temperature T of the continuous stirring type reactor is 200° C. or higher.

In some embodiments, the solvent may comprise a purified and recycled solvent.

In some embodiments, the solvent may comprise any one or two or more selected from pentane, hexane, cyclohexane, methylcyclohexane, heptane, octane, decane, and/or isopentane.

In some embodiments, the polymerization temperature T of the continuous stirring type reactor may be 210° C. or higher.

In some embodiments, the polymerization temperature T of the continuous stirring type reactor may be 220° C. or higher.

In some embodiments, the polymerization temperature T of the continuous stirring type reactor may be 230° C. or higher.

In some embodiments, the scavenger may comprise a scavenger represented by the following Chemical Formula 1:

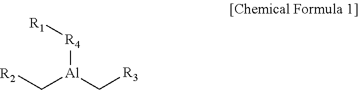

wherein R₁, R₂, and R₃ are each independently C₁-C₁₀ alkyl, C₆-C₁₀ aryl, or hydrogen, and R₄ is C₁-C₁₀ alkylene, O, or N.

In some embodiments, the second mixture may further comprise the scavenger.

In some embodiments, a first scavenger and a second scavenger may be chemically the same as or different from each other.

In some embodiments, relative weight contents of the first scavenger and the second scavenger may be represented by the following Equation 1:

$$0.5 < \frac{first scavenger}{second scavenger} < 1.7 \qquad [ Equation 1 ]$$

In some embodiments, the second mixture may comprise a cocatalyst and/or a molecular weight modifier.

Also provided is a manufacturing process of supplying a first mixed solution comprising a monomer comprising ethylene, a solvent, and a scavenger and a second mixed solution comprising a Ziegler-Natta unsupported catalyst and a solvent to a continuous reactor to perform polymerization at a high temperature of 200° C. or more.

Other features and aspects will be apparent from the following detailed description, the drawings, and the claims.

### DESCRIPTION OF THE INVENTION

Hereinafter, the present disclosure will be described in more detail with reference to specific examples and exemplary embodiments including the accompanying drawings. However, the following specific examples and exemplary embodiments are only a reference for describing the present disclosure in detail, and the present disclosure is not limited thereto and may be implemented in various forms.

In addition, unless otherwise defined, all technical terms and scientific terms have the same meanings as those commonly understood by one of those skilled in the art to which the present disclosure pertains. The terms used herein are only for effectively describing a certain specific example, and are not intended to limit the present disclosure.

In addition, the singular form used in the specification and claims appended thereto may be intended to also include a plural form, unless otherwise indicated in the context. As used herein, the singular form of “a”, “an”, and “the” include plural referents unless the context clearly states otherwise.

In addition, unless explicitly described to the contrary, a part “comprising” or “including” a constituent element will be understood to imply further inclusion of other constituent elements rather than the exclusion of any other constituent elements.

The numerical range used in the present specification comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present disclosure. Unless otherwise defined in the present specification, values which may be outside a numerical range due to experimental error or rounding off of a value are also comprised in the defined numerical range.

For the purposes of this specification, unless otherwise indicated, all numbers expressing quantities of ingredients, reaction conditions, dimensions, physical characteristics, and so forth used in the specification and claims are to be understood as being modified in all instances by the term “about.” Hereinafter, unless otherwise particularly defined in the present specification, “about” may be considered as a value within 30%, 25%, 20%, 15%, 10%, 5%, 3%, 2%, 1%, 0.5%, 0.1%, 0.05% or 0.01 of a stated value. Unless indicated to the contrary, the numerical parameters set forth in the following specification and attached claims are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Unless otherwise particularly defined in the present specification, a “polymer” refers to a molecule which has a relatively high molecular weight, and its structure may comprise multiple structural units of the same or different types and/or multiple repetition of a unit derived from a low molecular weight material or monomer. Examples of polymers include homopolymers, oligomers, and copolymers. In some embodiments, the polymer may be a homopolymer (for example, a polymer prepared from or comprising one monomer, such as a polyethylene polymer prepared from ethylene monomer). The term “oligomer” means a polymer consisting of only a few monomer units up to about ten monomer units, for example a dimer, trimer or tetramer. In some embodiments, the polymer may be a copolymer, such as an alternating copolymer, a block copolymer, a random copolymer, a graft copolymer, a gradient copolymer, a branched copolymer, a crosslinked copolymer, or a copolymer comprising all of them (for example, a polymer comprising more than one monomer).

As used herein, “polyethylene polymer” is a polymer polymerized from a monomer comprising ethylene, optionally with one or more comonomers.

As used herein, an “unsupported catalyst” is a catalyst used in bulk form, rather than a catalyst deposited on a solid support.

The term “polymerization” in the present disclosure is used to mean homopolymerization or copolymerization, and the term “polymer” is used to mean homopolymer or copolymer.

A metallocene catalyst in a conventional polyethylene polymerization method has a merit of having better physical properties than a Ziegler-Natta catalyst, but has a narrower PDI value than the Ziegler-Natta catalyst and has decreased processability of a polyethylene resin. Accordingly, a study for providing a polyethylene resin having excellent processability using the Ziegler-Natta catalyst continues.

Among the Ziegler-Natta catalysts, an unsupported catalyst has basically higher high-temperature stability than the Ziegler-Natta supported catalyst at 200° C. or higher, but side reactions may occur in a catalyst deactivation and removal process and the like to produce impurities.

Accordingly, in the conventional polyethylene polymerization method, when polyethylene is polymerized with an unsupported catalyst at a high temperature, a decrease in catalytic activity is rapidly increased, and thus, it is difficult to mass-produce polyethylene.

In some embodiments, the present disclosure provides a polyethylene manufacturing process comprising: supplying a first mixture comprising a monomer comprising ethylene, a solvent, and a scavenger to a continuous stirring type reactor through a first line; supplying a second mixture comprising a Ziegler-Natta catalyst to the continuous stirring type reactor through a second line; and manufacturing a polyethylene polymer in the continuous stirring type reactor, wherein a polymerization temperature T of the continuous stirring type reactor is 200° C. or higher, thereby providing a polyethylene manufacturing method having excellent productivity even when using a recycled solvent at 200° C. or higher.

In some embodiments, the monomer comprises ethylene, optionally with one or more comonomers. For example, the polyethylene polymer may be a polymer polymerized from ethylene monomer, a polymer polymerized from monomer(s) comprising ethylene, or a polymer polymerized from monomer(s) comprising ethylene and other comonomer(s) such as aliphatic unsaturated hydrocarbons (olefin, diene) and the like.

The ethylene gas and comonomer input ratio may be 1:0.001 to 1.5 ethylene:comonomer on a molar basis, but is not limited thereto.

In some embodiments, the comonomer may be any one or more comonomers selected from propylene, 1-butene, 1-pentene, 4-methyl-1-pentene, 1-hexene, 1-heptene, and/or 1-octene, and for example, any one or more comonomers selected from 1-hexene, 1-heptene, and 1-octene, but is not limited thereto as long as it is a comonomer used in usual polyethylene polymerization.

In some embodiments, in order to perform polyethylene polymerization at a high temperature, a pure solvent may be used, but since catalyst replacement may be expensive, it is efficient to recycle and use the solvent. However, the recycled solvent may comprise impurities produced in the polyethylene manufacturing process, and is highly likely to decrease catalytic activity.

Thus, in some embodiments, the present disclosure introduces the polyethylene polymerization method, thereby minimizing a decrease in activity of an unsupported Ziegler-Natta catalyst even at 200° C. or higher to polymerize polyethylene, and this, it is economical and has excellent productivity.

In some examples, the first mixture is a solution and/or the second mixture is a solution.

In some embodiments, the solvent may be a purified and recycled solvent, and though a method of purifying the solvent is not limited, the solvent may be purified using a purification step; and an adsorption step after the purification step, as an example. As an example, it may be a recycled solvent obtained by separating materials in the solvent by a distillation column and then adsorbing and purifying foreign matter in the solvent using an adsorbent such as a silica gel or zeolite-based adsorbents, but is only an example, and is not limited thereto.

In some embodiments, the type of solvent may comprise any one or two or more selected from pentane, hexane, cyclohexane, methylcyclohexane, heptane, octane, decane, and/or isopentane, but is not limited thereto.

The content of the solvent may be 300 to 1000 parts by weight based on 100 parts by weight of ethylene gas, but is not limited thereto.

In some embodiments, a mixture in which the purified solvent, a scavenger, and a monomer are mixed is added to a continuous reactor through a first line, an unsupported Ziegler-Natta catalyst is added through a second line, and then polyethylene polymerization may be performed at a polymerization temperature of 200° C. or higher.

In some embodiments, the polymerization temperature T of the mixture of the first mixture and the second mixture may be 200° C. or higher, 210° C. or higher, 220° C. or higher, or 230° C. or higher as a lower limit and 400° C. or lower or 300° C. or lower as an upper limit, and for example, may be 200 to 400° C., or 220 to 300° C.

In some embodiments, the Ziegler-Natta catalyst may comprise an unsupported Ziegler-Natta catalyst.

A transition metal compound and an organic metal compound which are the components of the unsupported Ziegler-Natta catalyst in some embodiments will be described.

In some embodiments, the transition metal compound may comprise one or more of halides, alkoxides, and/or phenoxides of any one metal selected from titanium (Ti), zirconium (Zr), hafnium (Hf), vanadium (V), niobium (Nb), and/or tantalum (Ta). In some embodiments, the transition metal compound may comprise a titanium (Ti) halide and/or a titanium (Ti) ethoxylate, but is not limited thereto. In some embodiments, the transition metal compound may comprise a titanium (Ti) chloride, but is not limited thereto.

The content of the transition metal compound may be 0.1 to 100 ppm per weight of ethylene, but is not limited thereto.

In some embodiments, an organometallic compound may comprise one or more of alkyl compounds, alkyl halides, and/or aryl compounds of any one metal selected from aluminum (Al), lithium (Li), magnesium (Mg), and/or zinc (Zn). In some embodiments, the organometallic compound may comprise an organoaluminum (Al) compound, but is not limited thereto.

The content of the organometallic compound may be 1 to 200 ppm per weight of ethylene, but is not limited thereto.

In some embodiments, the organoaluminum compound may comprise any one or two or more of triethyl aluminum, triisobutyl aluminum, trihexyl aluminum, diethylaluminum hydride, diisobutylaluminum hydride, diethylaluminum chloride, di-n-propylaluminum chloride, di-n-butylaluminum chloride, di-i-butylaluminum chloride, ethylaluminum dichloride, diethylaluminum ethoxide, i-butylaluminum dichloride, and/or n-octylaluminum, and for example, may comprise any one or two or more of diethylaluminum chloride, di-n-propylaluminum chloride, di-n-butylaluminum chloride, and di-i-butylaluminum chloride, and/or diethylaluminum ethoxide.

By using the unsupported Ziegler-Natta catalyst, basic activity is excellent at a high temperature of 200° C. or higher, but activity may be decreased due to impurities produced in the polyethylene manufacturing process.

Thus, by including a scavenger in the first mixture added from the first line to the continuous reactor, a problem of an increase in an added catalyst amount during operation for a long time may be solved while catalytic activity is excellent, even when polymerization is performed at 200° C. or higher in the continuous reactor.

In some embodiments, the polymerization time may be 1 minute or more, 2 minutes or more, 3 minutes or more, 4 minutes or more, or 5 minutes or more as a lower limit and 10 minutes or less, 9 minutes or less, 8 minutes or less, or 7 minutes or less as an upper limit, and for example, may be 1 to 10 minutes, 1 to 7 minutes, 1 to 6 minutes, or 1 to 5 minutes, but is not limited thereto.

In some embodiments, the scavenger may comprise a scavenger represented by the following Chemical Formula 1, and for example, may be triethylaluminum, tributylaluminum, trioctylaluminum or diethylaluminum ethoxide, but is not limited thereto:

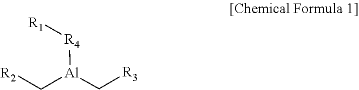

wherein R₁, R₂, and R₃ are each independently C₁-C₁₀ alkyl, C₆-C₁₀ aryl, or hydrogen, and R₄ is C₁-C₁₀ alkylene, O, or N.

In some embodiments, in Chemical Formula 1, R₁, R₂, or R₃ are each independently C₁-C₅ alkyl or hydrogen, and R₄ is C₁-C₁₀ alkylene.

The content of the scavenger may be 0.01 to 100 ppm per the solvent weight, but is not limited thereto.

Since the first mixture comprises the scavenger, the scavenger may strongly react with impurities inside a recycled solvent or a new or pure solvent and also serve as a cocatalyst during polyethylene polymerization, and as the first mixture and the second mixture are mixed, catalytic activity may be maintained for a long time even at 200° C. or higher.

In some embodiments, the second mixture may further comprise the scavenger. Since the second mixture further comprises the scavenger, activity and lifespan of the catalyst may be better.

In some embodiments, the first scavenger and the second scavenger may be chemically the same as or different from each other, but is not limited thereto. For example, both of the first scavenger and the second scavenger may be triethylaluminum, or the first scavenger may be triethylaluminum and the second scavenger may be triethylaluminum, tributylaluminum, trioctylaluminum or diethylaluminum ethoxide.

In some embodiments, relative Weight contents of the first scavenger and the second scavenger may be represented by the following Equation 1, but are not limited thereto:

$$0.5 < \frac{first scavenger}{second scavenger} < 1.7 \qquad [ Equation 1 ]$$

In some embodiments, the first mixture may comprise a cocatalyst and/or a molecular weight modifier.

In some embodiments, the cocatalyst may be any cocatalyst known for the purpose, and for example, may be an aluminum-containing cocatalyst, a boron-containing cocatalyst, and or a fluorinated catalyst. In some embodiments, the aluminum-containing cocatalyst may comprise alumoxane, alkylaluminum, a Lewis acid, and/or a fluorinated catalytic support, but is not limited thereto as long as it is a cocatalyst commonly used in polyethylene polymerization.

the Ziegler-Natta catalysts may be 0.5 to 30 ppm relative to the weight of the solvent, 1 to 30 ppm relative to the weight of the solvent, and 1 to 20 ppm relative to the weight of the solvent, but is not limited thereto.

Additionally, the cocatalyst may have a molar ratio of 1 to 10 times that of the Ziegler-Natta catalyst, but is not limited thereto.

In some embodiments, the molecular weight modifier may be an olefin-based hydrocarbon such as hydrogen, acetone, propionaldehyde, methyl ethyl ketone, propane, propylene, 1-butene, isobutene, pentene, hexene, heptene, and/or octene, but is not limited thereto as long as it is a common molecular weight modifier used in polyethylene polymerization.

The content of the molecular weight modifier may be 0.1 to 100 ppm per the solvent weight, but is not limited thereto.

Hereinafter, the present disclosure will be described in more detail with reference to the examples and the comparative examples. However, the following examples and comparative examples are only an example for describing the present disclosure in more detail, and do not limit the present disclosure in any way.

### Example 1

1 kg of cyclohexane, 200 ml of 1-octene, and 600 ml of hydrogen were added to a 3 L batch reactor, and ethylene was supplied at a pressure of 30 bar. Thereafter, 10 mg of impurities (2-heptanone) and 30 ml of cyclohexane including 6 mg of triethylaluminum as a scavenger were supplied from a first line and tetratitanium chloride (TiCl₄) (3 mg), vanadium oxychloride (3 mg), diethylaluminum chloride (8 mg), and diethylaluminum ethoxide (12 mg) were supplied from a second line to perform a polymerization reaction. The polymerization reaction conditions were at 230° C. for 3 minutes, and a polymer solution polymerized after completing the reaction was dried after drain to obtain a polymer.

### Example 2

The process was performed in the same manner as in Example 1, except that 12 mg of triethylaluminum was added instead of 6 mg.

### Example 3

The process was performed in the same manner as in Example 1, except that 18 mg of triethylaluminum was added instead of 6 mg.

### Example 4

The process was performed in the same manner as in Example 1, except that 24 mg of triethylaluminum was added instead of 6 mg.

### Comparative Example 1

The process was performed in the same manner as in Example 1, except that the scavenger (triethylaluminum) was not added.

TABLE 1

| | Polymer Yield (g) |
|---|---|
| Example 1 | 30 |
| Example 2 | 70 |
| Example 3 | 74 |
| Example 4 | 53 |
| Comparative Example 1 | 0 |

As shown in Table 1, use of the scavenger triethylaluminum in the polyethylene polymerization process provided significant Polymer (polyethylene) yield of 30 g to 74 g compared to the Comparative Example which did not include the scavenger and had zero Polymer yield.

Since polyethylene is polymerized by the polyethylene polymerization process of the present disclosure, a decrease in catalytic activity is minimized while a catalyst lifespan is maintained even at a high temperature, and thus, polyethylene may be continuously polymerized in large quantities with a relatively small amount of a catalyst added.

Also, the polyethylene polymerization method of the present disclosure may suppress occurrence of a side reaction as much as possible even when a purified recycled solvent is used.

Hereinabove, although the present disclosure has been described by specific matters, limited exemplary embodiments, and drawings, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit of the present disclosure should not be limited to the above-described exemplary embodiments, and the following claims as well as all modified equally or equivalently to the claims are intended to fall within the scope and spirit of the disclosure.

What is claimed is:

1. A polyethylene manufacturing process comprising:
supplying a first mixture comprising a monomer comprising ethylene, a solvent, and a scavenger to a continuous stirring type reactor through a first line;
supplying a second mixture comprising a Ziegler-Natta unsupported catalyst to the continuous stirring type reactor through a second line; and
manufacturing a polyethylene polymer in the continuous stirring type reactor,
wherein a polymerization temperature T of the continuous stirring type reactor is 200° C. or higher.

2. The polyethylene manufacturing process of claim 1, wherein the solvent is a purified and recycled solvent.

3. The polyethylene manufacturing process of claim 2, wherein the solvent is any one or two or more selected from pentane, hexane, cyclohexane, methylcyclohexane, heptane, octane, decane, isopentane, or mixtures thereof.

4. The polyethylene manufacturing process of claim 1, wherein a polymerization temperature T of the continuous stirring type reactor is 210° C. or higher.

5. The polyethylene manufacturing process of claim 1, wherein a polymerization temperature T of the continuous stirring type reactor is 220° C. or higher.

6. The polyethylene manufacturing process of claim 1, wherein a polymerization temperature T of the continuous stirring type reactor is 230° C. or higher.

7. The polyethylene manufacturing process of claim 1, wherein the scavenger comprises a scavenger represented by the following Chemical Formula 1: 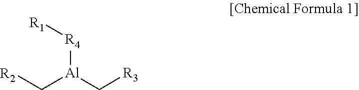
wherein R₁, R₂, and R₃ are each independently C₁-C₁₀ alkyl, C₆-C₁₀ aryl, or hydrogen, and R₄ is C₁-C₁₀ alkylene, O, or N.

8. The polyethylene manufacturing process of claim 1, wherein the second mixture further comprises a scavenger.

9. The polyethylene manufacturing process of claim 8, wherein the first scavenger and the second scavenger are chemically the same as or different from each other.

10. The polyethylene manufacturing process of claim 1, wherein relative weight contents of the first scavenger and the second scavenger are represented by the following Equation 1:
$$0.5 < \frac{first scavenger}{second scavenger} < 1.7 \qquad [ Equation 1 ]$$

11. The polyethylene manufacturing process of claim 1, wherein the second mixture comprises a cocatalyst and/or a molecular weight modifier.
